(19) United States
(12) Patent Application Publication
(10) Pub. No.: US 2025/0046993 A1
(43) Pub. Date: Feb. 6, 2025

(54) CONTROL STATION, PROCESSING SYSTEM, PROCESSING METHOD, AND RECORDING MEDIUM

(71) Applicant: NEC Corporation, Tokyo (JP)

(72) Inventors: Sou OFUDE, Tokyo (JP); Yoshiyuki ISHII, Tokyo (JP); Kenichi HOSHI, Tokyo (JP); Mizuki NIKAIDO, Tokyo (JP)

(73) Assignee: NEC Corporation, Tokyo (JP)

(21) Appl. No.: 18/786,791

(22) Filed: Jul. 29, 2024

(30) Foreign Application Priority Data
Aug. 1, 2023 (JP) 2023-125346

(51) Int. Cl. H01Q 3/08; G01S 19/25

(52) U.S. Cl. CPC H01Q 3/08; G01S 19/25

(57) ABSTRACT

A control station includes: a memory configured to store instructions; and a processor configured to execute instructions to: acquire, from a first satellite being tracked, information pertaining to a position of the first satellite in three-dimensional space in a case where the control station is unable to communicate with any other control stations via a communication network; and control an orientation of an antenna based on the information pertaining to the position of the first satellite in the three-dimensional space.

This application is based upon and claims the benefit of priority from Japanese patent application No. 2023-125346, filed on Aug. 1, 2023, the disclosure of which is incorporated herein in its entirety by reference.

### TECHNICAL FIELD

The present disclosure relates to a control station, a processing system, a processing method, and a recording medium.

### BACKGROUND ART

Antenna apparatuses that communicate while tracking satellites include antennas having axes (hereinafter referred to as the “AZ axis” and the “EL axis”) on which an azimuth angle (AZ angle) and an elevation angle (EL angle) are respectively adjusted, and track the satellites while adjusting the angles about the AZ axis and the EL axis. European Publication No. 3493428 discloses technology related to a command system including ground stations that communicate with each other via a communication network (IP network) as a related art. Japanese Publication No. 2011-005985 discloses technology related to an apparatus that determines the orbit of an artificial satellite as a related art. Japanese Publication No. H10-072000 discloses technology related to an apparatus that determines the posture of an artificial satellite as a related art.

### SUMMARY

The tracking of a satellite by an antenna apparatus is generally realized by a control station included in that antenna apparatus and another control station transmitting and receiving information necessary for the tracking with each other via a communication network. For this reason, in general, in a case where the communication network between the control station provided with that antenna apparatus and the other control station is blocked, the antenna apparatus cannot track the satellite. Therefore, technology allowing an antenna to track a satellite being tracked, even in a state in which a control station cannot communicate with the other control stations via a communication network, is sought.

An example objective of aspects of the present disclosure is to provide a control station, a processing system, a processing method, and a program that can solve the problems mentioned above.

According to one example embodiment of the present disclosure, a control station includes: a memory configured to store instructions; and a processor configured to execute instructions to: acquire, from a first satellite being tracked, information pertaining to a position of the first satellite in three-dimensional space in a case where the control station is unable to communicate with any other control stations via a communication network; and control an orientation of an antenna based on the information pertaining to the position of the first satellite in the three-dimensional space.

According to another example embodiment of the present disclosure, a processing system includes: the control station mentioned above; and the first satellite configured to communicate with the control station.

According to another example embodiment of the present disclosure, a processing method executed by a control station includes: acquiring, from a first satellite being tracked, information pertaining to a position of the first satellite in three-dimensional space in a case where the control station is unable to communicate with any other control stations via a communication network; and controlling an orientation of an antenna based on the information pertaining to the acquired position of the first satellite in three-dimensional space.

According to another example embodiment of the present disclosure, a non-transitory computer-readable recording medium storing a program causes a computer system included in a control station, to execute: acquiring, from a first satellite being tracked, information pertaining to a position of the first satellite in three-dimensional space in a case where the control station is unable to communicate with any other control stations via a communication network; and controlling an orientation of an antenna based on the information pertaining to the acquired position of the first satellite in three-dimensional space.

According to the example aspects of the present disclosure, an antenna can track a satellite being tracked, even in a state in which a control station is unable to communicate with the other control stations via a communication network.

### BRIEF DESCRIPTION OF THE DRAWINGS

FIG. 1 is a diagram illustrating an example of the configuration of a processing system according to a first example embodiment of the present disclosure.

FIG. 2 is a diagram illustrating an example of the configuration of a first satellite according to the first example embodiment of the present disclosure.

FIG. 3 is a diagram illustrating an example of the configuration of a first control station according to the first example embodiment of the present disclosure.

FIG. 4 is a diagram illustrating an example of the configuration of a prediction value output apparatus according to the first example embodiment of the present disclosure.

FIG. 5 is a diagram illustrating an example of the configuration of an antenna apparatus according to the first example embodiment of the present disclosure.

FIG. 6 is a diagram illustrating an example of the processing flow in the processing system according to the first example embodiment of the present disclosure.

FIG. 7 is a diagram illustrating an example of the configuration of a processing system according to a second example embodiment of the present disclosure.

FIG. 8 is a diagram illustrating an example of the configuration of a first satellite according to the second example embodiment of the present disclosure.

FIG. 9 is a diagram illustrating an example of the configuration of a prediction value output apparatus according to the second example embodiment of the present disclosure.

FIG. 10 is a diagram illustrating an example of the configuration of a second control station according to the second example embodiment of the present disclosure.

FIG. 11 is a diagram illustrating an example of the processing flow in the processing system according to the second example embodiment of the present disclosure.

FIG. 12 is a diagram illustrating the minimum configuration of a control station according to an example embodiment of the present disclosure.

FIG. 13 is a diagram illustrating an example of the processing flow in the control station with the minimum configuration according to an example embodiment of the present disclosure.

FIG. 14 is a schematic block diagram illustrating the configuration of a computer according to at least one example embodiment.

### EXAMPLE EMBODIMENT

Hereinafter, example embodiments will be explained in detail with reference to the drawings.

### (First Example Embodiment)

### (Configuration of Processing System)

A processing system 1 according to a first example embodiment of the present disclosure will be explained with reference to the drawings. The processing system 1 is a system that allows an antenna to track a satellite even in the case in which a communication network between a tracking control station and the other control stations is blocked.

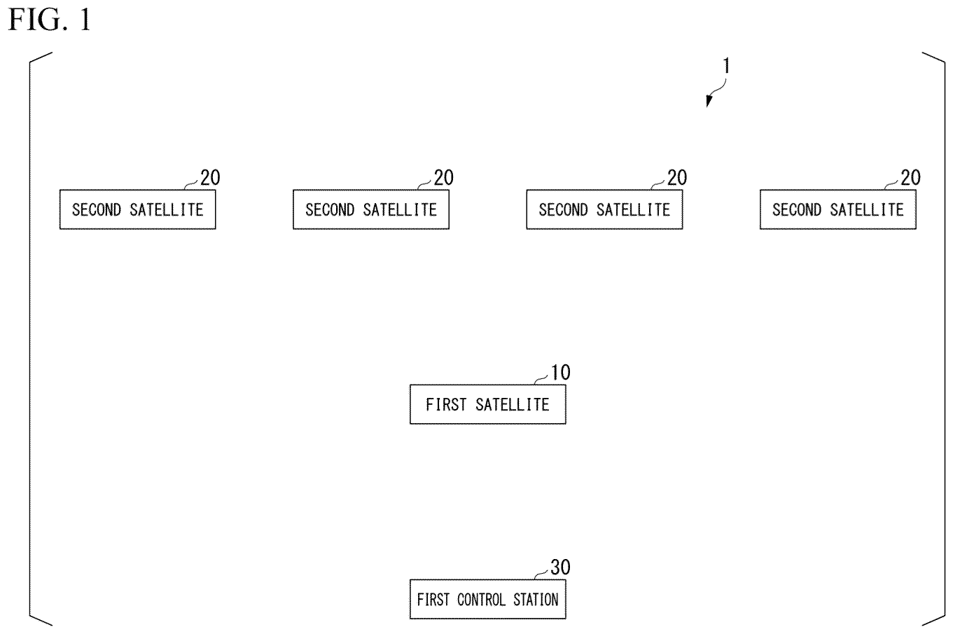

FIG. 1 is a diagram illustrating an example of the configuration of the processing system 1 according to the first example embodiment of the present disclosure. The processing system 1, as illustrated in FIG. 1, includes a first satellite 10, a plurality of second satellites 20, and a first control station 30.

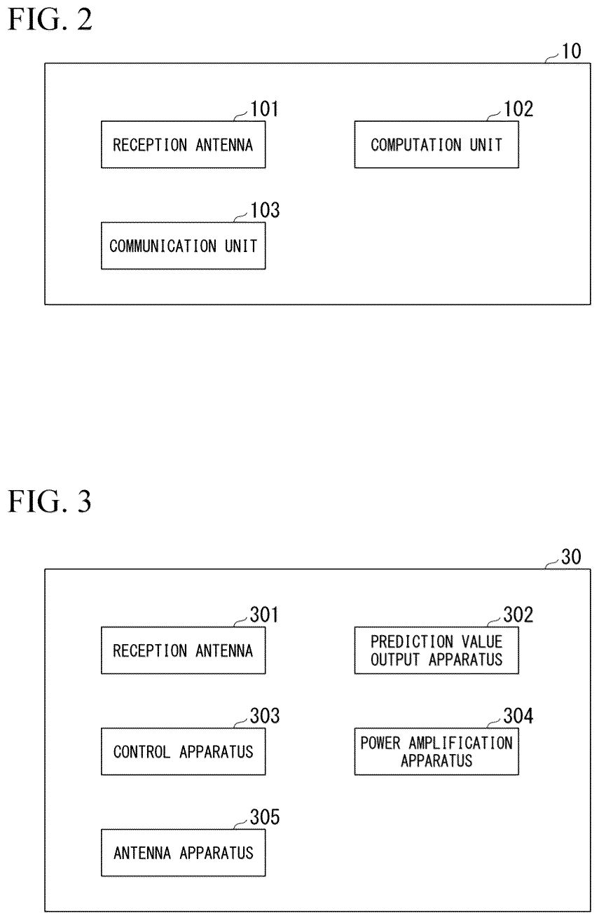

FIG. 2 is a diagram illustrating an example of the configuration of the first satellite 10 according to the first example embodiment of the present disclosure. The first satellite 10, as illustrated in FIG. 2, includes a reception antenna 101, a computation unit 102, and a communication unit 103. The first satellite 10 is a satellite being tracked by an antenna apparatus 305, to be described below.

The reception antenna 101 is an antenna for a GNSS (Global Navigation Satellite System). The reception antenna 101 receives radio waves from each of the plurality of second satellites 20.

The computation unit 102 calculates the position of the first satellite 10 at each of predetermined timings based on the radio waves received by the reception antenna 101. For example, the computation unit 102 may calculate the position of the first satellite 10 at each of the predetermined timings by using existing technology. Specifically, the GNSS may be a GPS (Global Positioning System) and the computation unit 102 may calculate the position of the first satellite 10 in the form of (x, y, z) coordinates in an xyz orthogonal coordinate system having a predetermined position in three-dimensional space as the reference point (origin) by performing computations similar to GPS positioning at each of the predetermined timings. An example of the predetermined position in three-dimensional space is the center of the Earth in an Earth-centered, Earth-fixed orthogonal coordinate system ECEF. The position of the first satellite 10, the positions of second satellites 20 to be described below, and the position of the antenna apparatus 305 to be described below can each be determined as (x, y, z) coordinates in ECEF.

The communication unit 103 transmits the calculation results (i.e., a plurality of sets of information in which timings are associated with positions corresponding to those timings) by the computation unit 102 to the first control station 30 as satellite position information.

The plurality of second satellites 20 are GNSS satellites. The first control station 30 is a control station located on the ground. The first control station 30 is, for example, a tracking control station. The first control station 30 orients the antenna 3051, to be described below, of the antenna apparatus 305 towards the direction in which the first satellite 10 is located. FIG. 3 is a diagram indicating an example of the configuration of the first control station 30 according to the first example embodiment of the present disclosure. The first control station 30, as illustrated in FIG. 3, includes a reception antenna 301, a prediction value output apparatus 302, a control apparatus 303, a power amplification apparatus 304, and an antenna apparatus 305.

The reception antenna 301 receives the satellite position information transmitted by the first satellite 10. For example, the reception antenna 301 is a choke ring antenna. A choke ring antenna can receive radio waves from all directions.

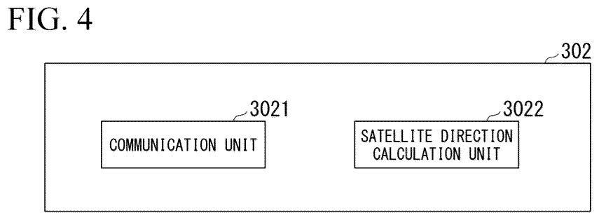

The prediction value output apparatus 302 is an apparatus that outputs an antenna prediction value indicating the direction of the first satellite 10 as seen from the position of the antenna apparatus 305. FIG. 4 is a diagram illustrating an example of the configuration of the prediction value output apparatus 302 according to the first example embodiment of the present disclosure. The prediction value output apparatus 302, as illustrated in FIG. 4, includes a communication unit 3021 and a satellite direction calculation unit 3022.

The communication unit 3021 communicates with the first satellite 10 via the reception antenna 301. For example, the communication unit 3021 receives satellite position information via the reception antenna 301.

The satellite direction calculation unit 3022 generates a prediction value of the movement direction of the first satellite 10 (i.e., the orbit of the first satellite 10) based on satellite position information received by the communication unit 3021. For example, in a case where the communication unit 3021 receives satellite position information, the satellite direction calculation unit 3022 calculates a future position (for example, at the timing at which the next satellite position information is to be received) of the first satellite 10 from past satellite position information and the latest satellite position information received by the communication unit 3021. Furthermore, for example, the satellite direction calculation unit 3022 generates, as a prediction value for the future position (i.e., at the timing at which the next satellite position information is to be received) of the first satellite 10, a vector (i.e. a direction and a length) directed to the position of the first satellite 10 at the timing at which the next satellite position information is to be received from the position of the first satellite 10 at the timing at which the latest satellite position information is to be received. The satellite direction calculation unit 3022 may generate prediction values for the positions of the first satellite 10 in shorter time intervals by interpolating the positions and timings between reception of the satellite position information by the communication unit 3021.

Additionally, the satellite direction calculation unit 3022 predicts the direction from the antenna apparatus 305 in the first control station 30 to the first satellite 10 as an antenna prediction value based on the prediction value of the movement direction (i.e., the satellite orbit) of the first satellite 10. The satellite direction calculation unit 3022 outputs the generated antenna prediction value to the control apparatus 303.

The control apparatus 303 generates a speed command based on the antenna prediction value output by the prediction value output apparatus 302. Specifically, the control apparatus 303 calculates an error from the antenna prediction value and the current antenna orientation direction, and generates a speed command such that the error becomes zero. The speed command generated by the control apparatus 303 is a speed command for controlling the rotation of motors 3055, to be described below, so as to orient the antenna 3051, to be described below, towards the position at which the first satellite 10 is located, assuming that the first satellite 10 moves in accordance with the antenna prediction value. The control apparatus 303 controls the rotation of the antenna apparatus 305 about axes (hereinafter referred to as the “AZ axis” and the “EL axis”) for respectively adjusting the azimuth angle (AZ angle) and the elevation angle (EL angle) by outputting the speed command to the power amplification apparatus 304. As a result thereof, the control apparatus 303 can orient the antenna 3051, to be described below, in a desired direction (for example, in the direction in which the first satellite 10 being tracked is located, and the like). The control apparatus 303 controls the azimuth angle and the elevation angle of the antenna 3051, to be described below, by controlling the rotation about the AZ axis and the rotation about the EL axis.

In response to the speed command output by the control apparatus 303, the power amplification apparatus 304 controls the torque of a motor 3055a, to be described below, for driving the AZ axis, and the torque of a motor 3055b, to be described below, for driving the EL axis, thereby transmitting torque, via speed reducers 3056 to be described below, to gears 3057, to be described below, for rotating the antenna 3051, to be described below. As a result thereof, the power amplification apparatus 304 can drive the antenna 3051, to be described below, in a desired direction.

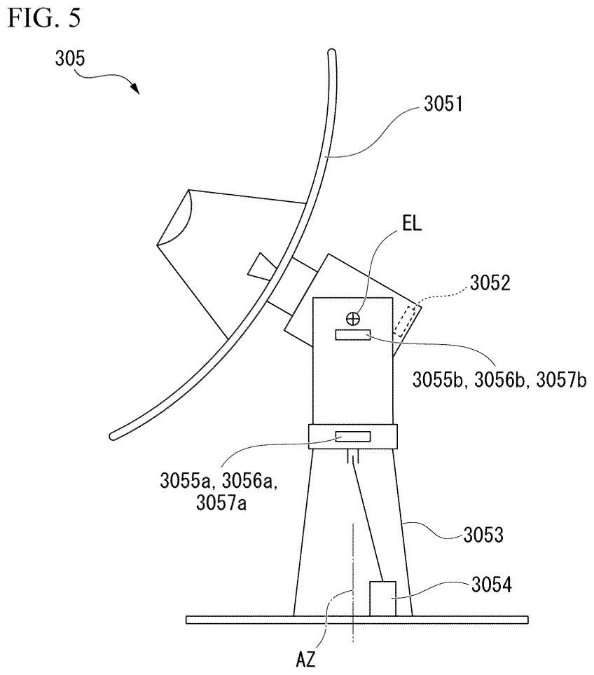

The antenna apparatus 305 is an apparatus that orients the antenna 3051, to be described below, towards the direction (i.e., tracking) in which the first satellite 10 is located, in accordance with the control signal generated by the control apparatus 303. FIG. 5 is a diagram illustrating an example of the configuration of the antenna apparatus 305 according to the first example embodiment of the present disclosure. The antenna apparatus 305, as illustrated in FIG. 5, includes an antenna 3051, antenna-side equipment 3052, a base 3053, base-side equipment 3054, motors 3055a, 3055b, speed reducers 3056a, 3056b, and gears 3057a, 3057b. The motors 3055a, 3055b will be collectively referred to as the motors 3055. The speed reducers 3056a, 3056b will be collectively referred to as the speed reducers 3056. The gears 3057a, 3057b will be collectively referred to as the gears 3057.

The antenna 3051 transmits and receives signals to and from the first satellite 10. The antenna 3051, such as a parabola antenna, a Cassegrain antenna, a Gregorian antenna, a ring focus antenna, and the like, has the function of using one or more reflectors having curved surfaces to collect reception signals at a focal position or to transmit transmission signals from the focal position to the reflectors.

The antenna-side equipment 3052, as illustrated in FIG. 5, is provided in a small compartment that is located behind a main reflective mirror and that rotates together with the EL axis. The antenna-side equipment 3052 transmits and receives signals with the antenna 3051. Additionally, the antenna-side equipment 3052 transmits and receives signals with the base-side equipment 3054. The base 3053 rotatably supports the antenna 3051 and the antenna-side equipment 3052.

The base-side equipment 3054 is provided inside the base 3053 or in the periphery of the base 3053. The base-side equipment 3054 transmits and receives signals with the antenna-side equipment 3052.

The motor 3055a, under torque control by the power amplification apparatus 304, drives the AZ axis via the speed reducer 3056a and the gear 3057a. The motor 3055b, under torque control by the power amplification apparatus 304, drives the EL axis via the speed reducer 3056 and the gear 3057b. The speed reducer 3056a reduces the rotation speed of the motor 3055a and obtains the torque necessary for driving the antenna 3051 to rotate the gear 3057a. The speed reducer 3056b reduces the rotation speed of the motor 3055b via the gear 3057b and obtains the torque necessary to drive the antenna 3051. The gear 3057a is a gear for rotating the antenna 3051 about the AZ axis. The gear 3057b is a gear for rotating the antenna 3051 about the EL axis.

### (Processes Performed by Processing System)

The processes described above performed by the processing system 1 are merely an example, and the processes performed by the processing system 1 according to the respective example embodiments of the present disclosure are not limited to the processes described above. For example, the processing system 1 may perform the processes explained below.

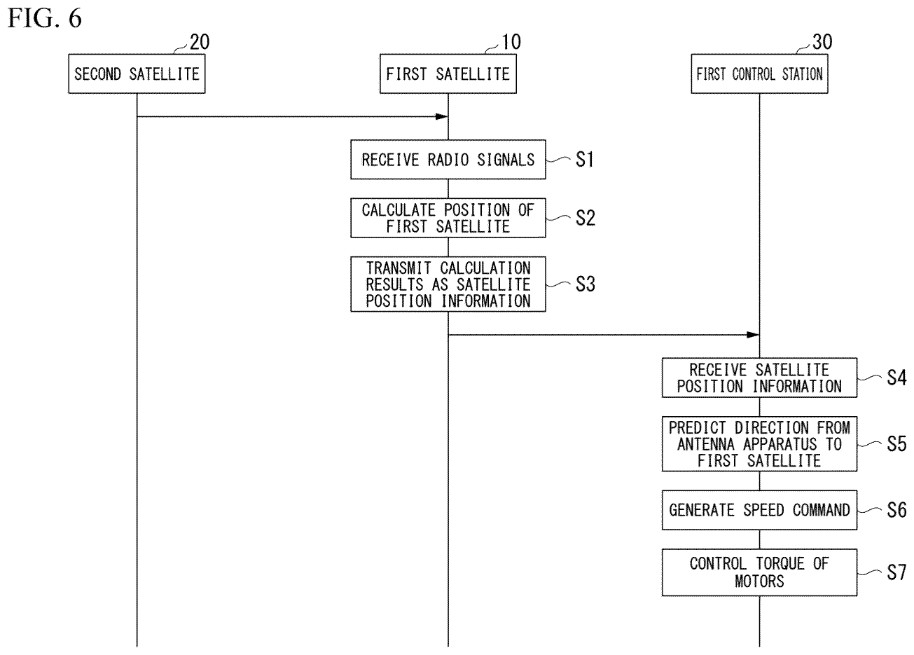

FIG. 6 is a diagram illustrating an example of the processing flow in the processing system 1 according to the first example embodiment of the present disclosure. Next, the process by which the processing system 1 orients the antenna 3051 towards the direction in which the first satellite 10 is located will be explained with reference to FIG. 6.

The reception antenna 101 receives radio waves from each of a plurality of second satellites 20 (step S1). The computation unit 102 calculates the position of the first satellite 10 at each of predetermined timings based on the radio waves received by the first reception antenna 101 (step S2). The communication unit 103 transmits calculation results (i.e., a plurality of sets of information in which timings are associated with positions corresponding to those timings) by the computation unit 102, as satellite position information, to the first control station 30 (step S3).

The communication unit 3021 receives, via the reception antenna 301, the satellite position information transmitted by the first satellite 10 (step S4). The satellite direction calculation unit 3022 generates a prediction value of the movement direction of the first satellite (i.e., the orbit of the first satellite 10) based on the satellite position information received by the communication unit 3021. The satellite direction calculation unit 3022 predicts the direction from the antenna apparatus 305 of the first control station 30 to the first satellite 10, as an antenna prediction value, based on the prediction value of the movement direction of the first satellite 10 (i.e., the orbit of the first satellite 10) (step S5). The satellite direction calculation unit 3022 outputs the generated antenna prediction value to the control apparatus 303.

The control apparatus 303 generates a speed command based on the antenna prediction value output by the prediction value output apparatus 302 (step S6). Specifically, the control apparatus 303 calculates the error between the antenna prediction value and the current antenna orientation direction, and generates a speed command such that the error becomes zero. The speed command generated by the control apparatus 303 is a speed command for controlling the rotation of the motors 3055, to be described below, so as to direct the antenna 3051, to be described below, towards the position at which the first satellite 10 is located, assuming that the first satellite 10 moves in accordance with the antenna prediction value. The control apparatus 303 outputs the speed command to the power amplification apparatus 304.

By doing so, the control apparatus 303 controls the rotation of the antenna apparatus 305 about the AZ axis for adjusting the azimuth angle (AZ angle) and about the EL axis for adjusting the elevation angle (EL angle).

The power amplification apparatus 304 controls the torque of the motor 3055a for driving the AZ axis and the torque of the motor 3055b for driving the EL axis in accordance with the speed command output by the control apparatus 303 (step S7), thereby transmitting torque, via the speed reducers 3056, to the gears 3057 for rotating the antenna 3051. As a result thereof, the power amplification apparatus 304 can orient the antenna 3051 in a desired direction (i.e., in the direction in which the first satellite 10 is located) in accordance with the speed command of the control apparatus 303.

### (Advantages)

The processing system 1 according to the first example embodiment of the present disclosure has been explained above. The first control station 30 (an example of a control station) in the processing system 1 is a control station that is in a state of being unable to communicate with the other control stations via a communication network. In the first control station 30, the communication unit 3021 (an example of an acquisition unit) acquires, from the first satellite 10 being tracked, information pertaining to the position of the first satellite 10 in three-dimensional space. The control apparatus 303 (an example of a control unit) controls the orientation of the antenna 3051 (an example of an antenna) based on the information pertaining to the position of the first satellite 10 in three-dimensional space, acquired by the communication unit 3021. Due to this first control station 30 (an example of a control station), the antenna can track the satellite being tracked, even in a state of being unable to communicate with the other control stations via a communication network.

### (Second Example Embodiment)

### (Configuration of Processing System)

A processing system 1 according to a second example embodiment of the present disclosure will be explained with reference to the drawings. The processing system 1 is a system that allows an antenna to track a satellite even in the case in which a communication network between a tracking control station and the other control stations is blocked. The explanation below will center on the differences from the processing system 1 according to the first example embodiment of the present disclosure.

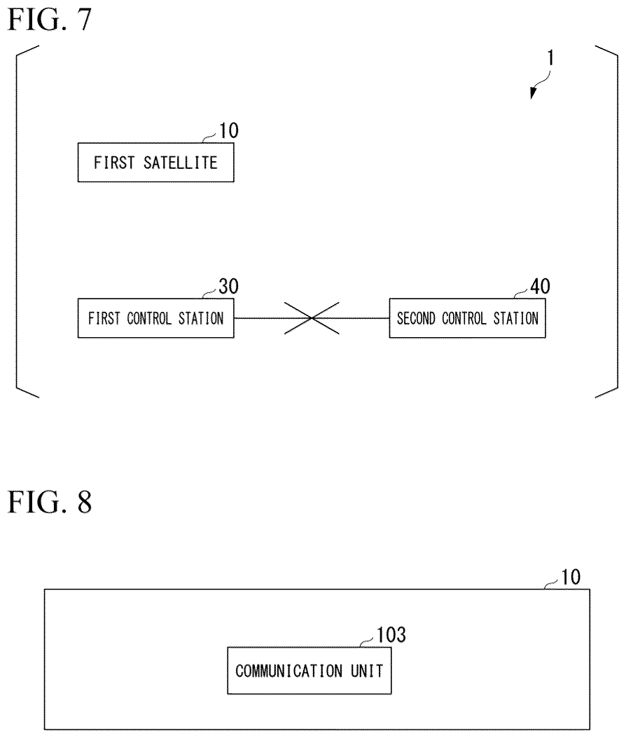

FIG. 7 is a diagram illustrating an example of the configuration of the processing system 1 according to the second example embodiment of the present disclosure. The processing system 1, as illustrated in FIG. 7, includes a first satellite 10 and a first control station 30. Additionally, the processing system 1, as illustrated in FIG. 7, includes a second control station 40.

FIG. 8 is a diagram illustrating an example of the configuration of the first satellite 10 according to the second example embodiment of the present disclosure. The first satellite 10, as illustrated in FIG. 8, includes a communication unit 103. The first satellite 10 is a satellite being tracked by an antenna apparatus 305.

The communication unit 103 communicates with the first control station 30 and the second control station 40. For example, the communication unit 103 receives an antenna prediction value, to be described below, generated by the second control station 40. Furthermore, the communication unit 103 transmits the received antenna prediction value to the first control station 30.

The first control station 30, like the first control station 30 according to the first example embodiment of the present disclosure, includes a reception antenna 301, a prediction value output apparatus 302, a control apparatus 303, a power amplification apparatus 304, and an antenna apparatus 305.

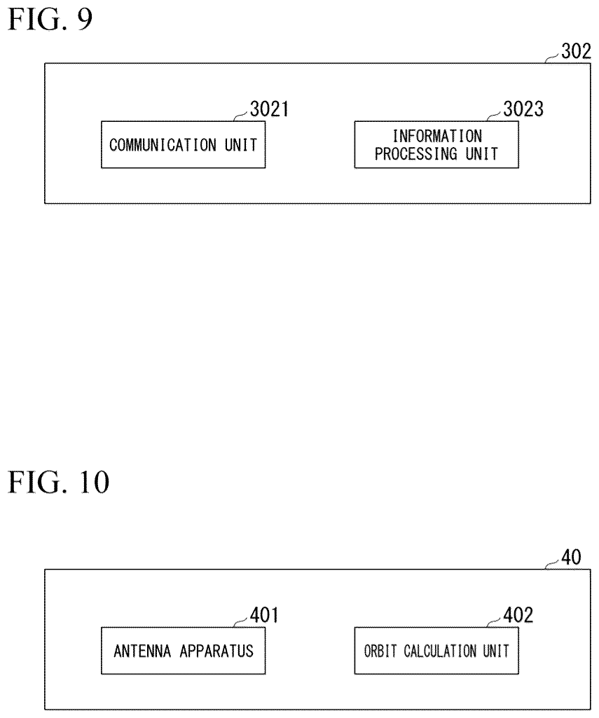

FIG. 9 is a diagram illustrating an example of the configuration of the prediction value output apparatus 302 according to the second example embodiment of the present disclosure. The prediction value output apparatus 302, as illustrated in FIG. 9, includes a communication unit 3021 and an information processing unit 3023. The communication unit 3021 communicates with the first satellite 10 via the reception antenna 301. For example, the communication unit 3021 receives an antenna prediction value, to be described below, generated by the second control station 40, via the reception antenna 301.

The control apparatus 303 calculates the antenna prediction value from satellite orbit information output by the communication unit 3021. The control apparatus 303 generates a speed command based on the antenna prediction value.

The second control station 40 is a control station that can predict the orbit on which the first satellite 10 will move. The technology used in a case where the second control station 40 predicts the orbit may be any technology. FIG. 10 is a diagram illustrating an example of the configuration of the second control station 40 according to the second example embodiment of the present disclosure. The second control station 40, as illustrated in FIG. 10, includes an antenna apparatus 401 and an orbit calculation unit 402.

The antenna apparatus 401 includes an antenna, and orients the antenna towards the direction in which the first satellite 10 being tracked is located, based on the orbit calculation results by the orbit calculation unit 402. The orbit calculation unit 402 acquires ranging data using GNSS and the like or ranging data determined from the roundtrip time of radio waves between the first satellite 10 and the antenna apparatus 401. The orbit calculation unit 402 identifies the variation in the distance between the first satellite 10 and the antenna apparatus 401 per unit time from the acquired ranging data, the direction of the antenna apparatus 401, and the installation position (latitude and longitude) of the antenna apparatus 401. Furthermore, the orbit calculation unit 402 generates a prediction value of the movement direction of the first satellite 10 in three-dimensional space (i.e., the orbit of the first satellite 10) from the latitude and longitude of the antenna apparatus 401, the current AZ angle of the antenna apparatus 401, the current EL angle of the antenna apparatus 401, the current distance (ranging data) from the antenna apparatus 401 to the first satellite 10, a future (i.e., at the timing at which the next satellite position information is to be received) AZ angle of the antenna apparatus 401, a future (i.e., at the timing at which the next satellite position information is to be received) EL angle of the antenna apparatus 401, and a future (i.e., at the timing at which the next satellite position information is to be received) distance (ranging data) from the antenna apparatus 401 to the first satellite 10. The orbit calculation unit 402 predicts, as the antenna prediction value, the direction from the antenna apparatus 305 of the first control station 30 to the first satellite 10 based on the prediction value of the movement direction of the first satellite 10 (i.e., the orbit of the first satellite 10). The orbit calculation unit 402 transmits the antenna prediction value from the antenna apparatus 401 to the first control station 30 via the first satellite 10.

The orbit calculation unit 402 does not merely predict the prediction value of the movement direction of the first satellite 10 (i.e., the orbit of the first satellite 10) and the antenna prediction value. For example, the orbit calculation unit 402 estimates the orbit of the first satellite 10 with high accuracy by collecting information from a plurality of control stations other than the first control station 30. Specifically, for example, the orbit calculation unit 402 collects satellite directions (AZ directions and EL directions) and ranging data from a plurality of control stations other than the first control station 30, and corrects error, and the like on the signal propagation paths to calculate satellite orbit information such as the six orbital elements (i.e., semi-major axis, eccentricity, inclination, argument of periapsis, longitude of ascending node, true anomaly at epoch) of the first satellite 10. Furthermore, the orbit calculation unit 402 may calculate the position of the first satellite 10 at an arbitrary timing from the satellite orbit information that has been calculated.

### (Processes Performed by Processing System)

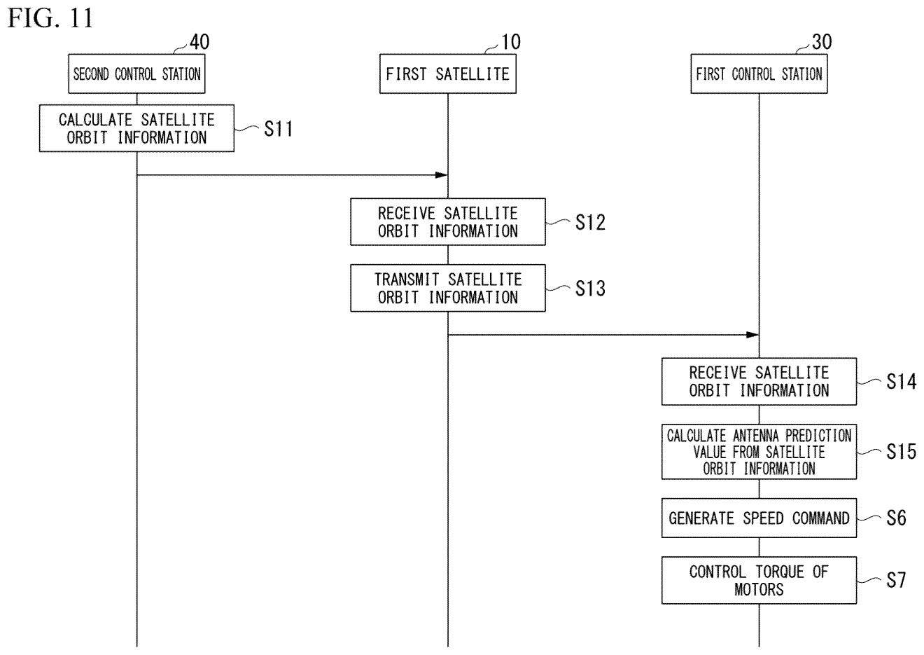

The processes described above performed by the processing system 1 are merely an example, and the processes performed by the processing system 1 according to the second example embodiment of the present disclosure are not limited to the processes described above. For example, the processing system 1 may perform the processes explained below. FIG. 11 is a diagram illustrating an example of the processing flow in the processing system 1 according to the second example embodiment of the present disclosure. Next, the process performed by the processing system 1 for orienting the antenna 3051 towards the direction in which the first satellite 10 is located will be explained with reference to FIG. 11.

The orbit calculation unit 402 collects satellite directions (AZ directions and EL directions) and ranging data from a plurality of control stations other than the first control station 30, and corrects error, and the like on the signal propagation paths to calculate satellite orbit information such as the six orbital elements (i.e., semi-major axis, eccentricity, inclination, argument of periapsis, longitude of ascending node, true anomaly at epoch) of the first satellite 10 (step S11). The orbit calculation unit 402 transmits the calculated satellite orbit information from the antenna apparatus 401 to the first satellite 10. The communication unit 103 receives the satellite orbit information from the second control station 40 (step S12). The communication unit 103 transmits the received satellite orbit information to the first control station 30 (step S13).

The communication unit 3021 receives, via the reception antenna 301, the satellite orbit information calculated by the second control station 40 (step S14). The communication unit 3021 outputs the received satellite orbit information to the control apparatus 303.

The control apparatus 303 calculates the antenna prediction value from its own position and the satellite orbit information output by the communication unit 3021 (step S15). The control apparatus 303 generates a speed command based on the antenna prediction value (step S6). The speed command generated by the control apparatus 303 is a speed command for controlling the rotation of the motors 3055 so as to orient the antenna 3051 towards the position in which the first satellite 10 is located, assuming that the first satellite 10 moves in accordance with the antenna prediction value. The control apparatus 303 outputs the speed command to the power amplification apparatus 304. By doing so, the control apparatus 303 controls the rotation of the antenna apparatus 305 about the AZ axis for adjusting the azimuth angle (AZ angle) and about the EL axis for adjusting the elevation angle (EL angle).

The power amplification apparatus 304 controls the torque of the motor 3055a for driving the AZ axis and the torque of the motor 3055b for driving the EL axis in accordance with the speed command output by the control apparatus 303 (step S7), thereby transmitting torque, via the speed reducers 3056, to the gears 3057 for rotating the antenna 3051. As a result thereof, the power amplification apparatus 304 can orient the antenna 3051 in a desired direction (i.e., in the direction in which the first satellite 10 is located) in accordance with the speed command from the control apparatus 303.

### (Advantages)

The processing system 1 according to the second example embodiment of the present disclosure has been explained above. The first control station 30 (an example of a control station) in the processing system 1 is a control station that is in a state of being unable to communicate with the second control station 40, which is another control station, via a communication network. In the first control station 30, the communication unit 3021 (an example of an acquisition unit) acquires, from the first satellite 10 being tracked, information pertaining to the position of the first satellite 10 in three-dimensional space (i.e., a prediction value of the movement direction of the first satellite 10 (i.e., the orbit of the first satellite 10) generated by the second control station 40). The control apparatus 303 (an example of a control unit) controls the orientation of the antenna 3051 (an example of an antenna) based on the information pertaining to the position of the first satellite 10 in three-dimensional space, acquired by the communication unit 3021. Due to this first control station 30 (an example of a control station), the antenna can track the satellite being tracked, even in a state of being unable to communicate with the other control stations via a communication network.

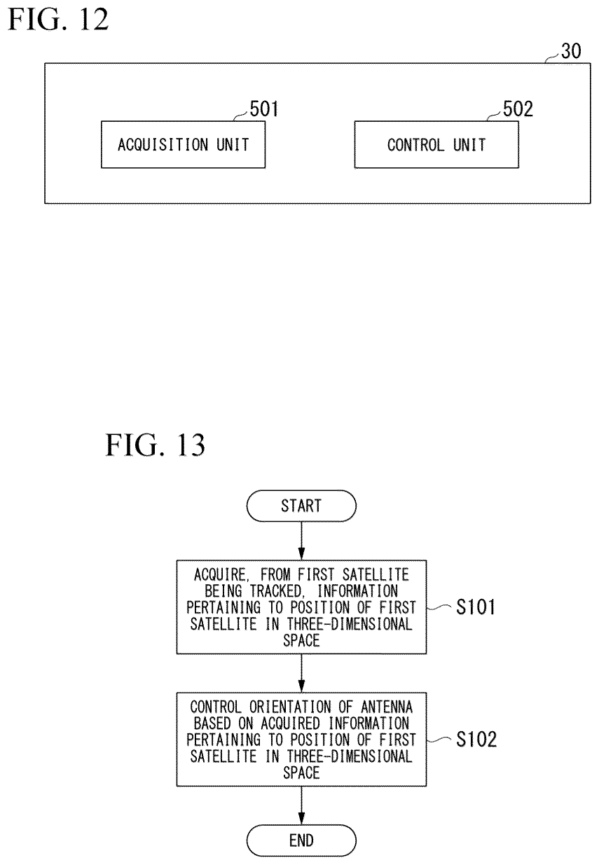

FIG. 12 is a diagram illustrating the minimum configuration of the control station 30 according to an example embodiment of the present disclosure. The control station 30, as illustrated in FIG. 12, includes an acquisition unit 501 and a control unit 502. The control station 30 is a control station that is in a state of being unable to communicate with the other control stations via a communication network.

The acquisition unit 501 acquires, from a first satellite being tracked, information pertaining to a position of the first satellite in three-dimensional space. The control unit 502 controls an orientation of an antenna based on the information pertaining to the position of the first satellite in three-dimensional space, acquired by the acquisition unit 501.

The acquisition unit 501 can be realized, for example, by using the functions of the communication unit 3021 illustrated in FIG. 4 and FIG. 9. The control unit 502 can be realized, for example, by using the functions of the control apparatus 303 illustrated in FIG. 3.

FIG. 13 is a diagram illustrating an example of the processing flow in the control station 30 with the minimum configuration according to the example embodiment of the present disclosure. Next, the processes in the control station 30 with the minimum configuration according to the example embodiment of the present disclosure will be explained with reference to FIG. 13.

The acquisition unit 501 acquires, from a first satellite being tracked, information pertaining to a position of the first satellite in three-dimensional space (step S101). The control unit 502 controls an orientation of an antenna based on the information pertaining to the position of the first satellite in three-dimensional space, acquired by the acquisition unit 501 (step S102).

The control station 30 with the minimum configuration according to the example embodiment of the present disclosure has been explained above. This control station 30 can allow an antenna to track a satellite being tracked, even in a state of being unable to communicate with the other control stations via a communication network.

In the processes in the example embodiments of the present disclosure, the order of the processes may be switched within a range in which appropriate processes are performed.

Although example embodiments of the present disclosure have been explained, the processing system 1, the first satellite 10, each of the a plurality of second satellites 20, the first control station 30, the second control station 40, and other control apparatuses described above may have internal computer systems. Furthermore, the steps in the processes described above are stored in a computer-readable recording medium in the form of a program and the above-mentioned processes are performed by a computer reading and executing this program. Specific examples of the computer will be indicated below.

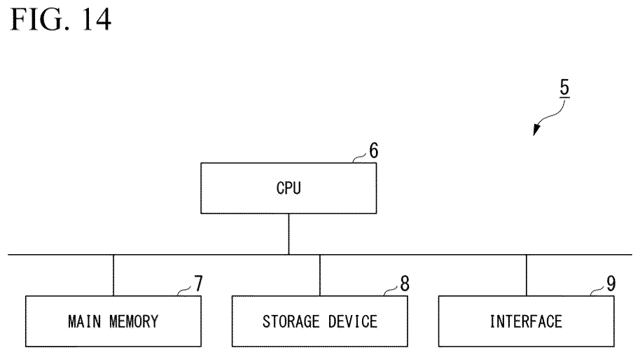

FIG. 14 is a schematic block diagram illustrating the configuration of a computer according to at least one example embodiment. The computer 5, as illustrated in FIG. 14, includes a CPU (Central Processing Unit) 6, a main memory 7, a storage device 8, and an interface 9.

For example, the processing system 1, the first satellite 10, each of the plurality of second satellites 20, the first control station 30, the second control station 40, and other control apparatuses described above may each be implemented by the computer 5. Furthermore, the operations of the respective processing units described above are stored in the storage device 8 in the form of a program. The CPU 6 reads the program from the storage device 8 and loads the program in the main memory 7, then executes the above-mentioned processes in accordance with said program. Additionally, the CPU 6 secures, in the main memory 7, storage areas corresponding to the respective storage units described above in accordance with the program.

Examples of the storage device 8 include HDDs (Hard Disk Drives), SSDs (Solid State Drives), magnetic disks, magneto-optic disks, CD-ROMs (Compact Disc Read-Only Memory), DVD-ROMs (Digital Versatile Disc Read-Only Memory), semiconductor memory, and the like. The storage device 8 may be internal media directly connected to a bus in the computer 5, or may be external media connected to the computer 5 by an interface 9 or by a communication line. Additionally, in the case in which the program is distributed to the computer 5 by a communication line, the computer 5 that has received the distribution may load the program in the main memory 7 and execute the above-mentioned processes. In at least one example embodiment, the storage device 8 is a non-transitory and tangible storage medium.

Additionally, the above-mentioned program may realize just some of the functions described above. Furthermore, the above-mentioned program may be a so-called difference file (difference program) that can realize the functions described above in combination with a program already recorded in a computer system.

While a number of example embodiments of the present disclosure have been explained, these example embodiments are merely exemplary and do not limit the scope of the disclosure. Various additions, omissions, substitutions, and modifications can be made to these example embodiments within a range not departing from the spirit of the disclosure.

Some or all of the above-mentioned example embodiments may be described as in the supplementary notes below, yet are not limited thereto.

### (Supplementary Note 1)

A control station includes:
a memory configured to store instructions; and
a processor configured to execute instructions to:
acquire, from a first satellite being tracked, information pertaining to a position of the first satellite in three-dimensional space in a case where the control station is unable to communicate with any other control stations via a communication network; and
control an orientation of an antenna based on the information pertaining to the position of the first satellite in the three-dimensional space.

### (Supplementary Note 2)

The control station according to Supplementary Note 1, wherein:
the information pertaining to the position of the first satellite in the three-dimensional space is information indicating a position of the first satellite in the three-dimensional space at each of predetermined timings;
the control station includes the processor configured to: predict a future position of the first satellite based on the information indicating the position of the first satellite in the three-dimensional space at each of the predetermined timings;
acquire the information pertaining to the position of the first satellite in the three-dimensional space at each of the predetermined timings from the first satellite; and
control the orientation of the antenna based on the future position of the first satellite.

### (Supplementary Note 3)

The control station according to Supplementary Note 1, wherein:
the information pertaining to the position of the first satellite in the three-dimensional space is information indicating a future position of the first satellite predicted by another control station;
the processor is configured to acquire, from the first satellite, the future position of the first satellite acquired by the first satellite communicating with the other control station; and
control the orientation of the antenna based on the future position of the first satellite.

### (Supplementary Note 4)

The control station according to any one of Supplementary Notes 1 to 3,wherein:
the processor is configured to control the orientation of the antenna by controlling rotation about an axis for adjusting an azimuth angle of the antenna and rotation about an axis for adjusting an elevation angle of the antenna.

### (Supplementary Note 5)

A processing system including:
the control station according to any one of Supplementary Notes 1 to 4; and the first satellite configured to communicate with the control station.

### (Supplementary Note 6)

A processing method executed by a control station, including: acquiring, from a first satellite being tracked, information pertaining to a position of the first satellite in three-dimensional space in a case where the control station is unable to communicate with any other control stations via a communication network; and controlling an orientation of an antenna based on the information pertaining to the acquired position of the first satellite in three-dimensional space.

### (Supplementary Note 7)

A non-transitory computer-readable recording medium storing a program causing a computer system included in a control station, to execute: acquiring, from a first satellite being tracked, information pertaining to a position of the first satellite in three-dimensional space in a case where the control station is unable to communicate with any other control stations via a communication network; and controlling an orientation of an antenna based on the information pertaining to the acquired position of the first satellite in three-dimensional space.

What is claimed is:

1. A control station comprising:
a memory configured to store instructions; and
a processor configured to execute instructions to:
acquire, from a first satellite being tracked, information pertaining to a position of the first satellite in three-dimensional space in a case where the control station is unable to communicate with any other control stations via a communication network; and
control an orientation of an antenna based on the information pertaining to the position of the first satellite in the three-dimensional space.

2. The control station according to claim 1, wherein:
the information pertaining to the position of the first satellite in the three-dimensional space is information indicating a position of the first satellite in the three-dimensional space at each of predetermined timings;
the control station comprises the processor configured to: predict a future position of the first satellite based on the information indicating the position of the first satellite in the three-dimensional space at each of the predetermined timings;
acquire the information pertaining to the position of the first satellite in the three-dimensional space at each of the predetermined timings from the first satellite; and
control the orientation of the antenna based on the future position of the first satellite.

3. The control station according to claim 1, wherein:
the information pertaining to the position of the first satellite in the three- dimensional space is information indicating a future position of the first satellite predicted by another control station;
the processor is configured to acquire, from the first satellite, the future position of the first satellite acquired by the first satellite communicating with the other control station; and
control the orientation of the antenna based on the future position of the first satellite.

4. The control station according to claim 1, wherein:
the processor is configured to control the orientation of the antenna by controlling rotation about an axis for adjusting an azimuth angle of the antenna and rotation about an axis for adjusting an elevation angle of the antenna.

5. A processing system comprising:
the control station according to claim 1; and
the first satellite configured to communicate with the control station.

6. A processing method executed by a control station, comprising:
acquiring, from a first satellite being tracked, information pertaining to a position of the first satellite in three-dimensional space in a case where the control station is unable to communicate with any other control stations via a communication network; and
controlling an orientation of an antenna based on the information pertaining to the acquired position of the first satellite in three-dimensional space.

7. A non-transitory computer-readable recording medium storing a program causing a computer system included in a control station, to execute:
acquiring, from a first satellite being tracked, information pertaining to a position of the first satellite in three-dimensional space in a case where the control station is unable to communicate with any other control stations via a communication network; and
controlling an orientation of an antenna based on the information pertaining to the acquired position of the first satellite in three-dimensional space.
